(19) United States
(12) Patent Application Publication
(10) Pub. No.: US 2006/0218528 A1
(43) Pub. Date: Sep. 28, 2006

(54) Software explorer

(75) Inventors: Matthew R. Lerner, Seattle, WA (US); Chris J. Guzak, Kirkland, WA (US); David A. Matthews, Seattle, WA (US); Cynthia C. Tee, Bellevue, WA (US); Charles W. Stabb, Seattle, WA (US)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Redmond, CA (US)

(21) Appl. No.: 11/085,601

(22) Filed: Mar. 22, 2005

(51) Int. Cl. G06F 9/44

(52) U.S. Cl. 717/120

(57) ABSTRACT

Computer-implemented methods for managing software installed on a computer are provided. A first region of an interface displays a selection of software information views, including installed software, running software, and software updates. Selecting a view causes a second region of the interface to display the view, including a list of software. Selecting one of the pieces of software displays additional information about the software in a third region of the interface. A fourth region of the interface displays commands associated with the selected software information view. User-friendly names are used throughout the interface.

### FIELD OF THE INVENTION

The invention relates generally to computer software. More particularly, aspects of the invention are directed to managing software installed on a computer.

### BACKGROUND OF THE INVENTION

Managing software on a computer has become a very difficult task. As computers have become more ubiquitous and important, their uses have increased exponentially. With each new use comes one or more pieces of software to fill the need, each of which a user may install and have to manage. This increased functionality has enabled users to complete their tasks with more efficiency, producing higher quality results. But the increase in the number of installed applications has made managing the library of software on a computer a daunting task for users.

Managing software on a computer frequently involves a user viewing information about software, and then acting on that information. For example, users may want to know what software is installed on a computer so that they may then decide what to install or remove. They may want to know what software is running to free up memory. They may want to know about unreliable or ill-behaved software so that they can troubleshoot a problem. They may want to know what software is running automatically so they can stop it from doing so. Or, they may want to restore their software to a previously saved state.

Prior art FIGS. 2A-2F depict just a few of the software management solutions that have been developed over time to assist users in these tasks. Each presents a different view of computer software installed on a computer. System configuration utility 202 in FIG. 2A displays filenames of software which are run automatically at startup. Task manager 203 in FIG. 2B displays the filenames of software presently running. Anti-spyware application 204 in FIG. 2C provides the application names of suspicious software presently installed. Add/Remove programs dialog 205 in FIG. 2D provides the application names of software presently installed. Services manager 206 in FIG. 2E provides the filenames of background services that are installed. Finally, operating system component manager 207 in FIG. 2F provides application names of software installed or available for installation.

Whereas each solution displayed in FIGS. 2A-2F may adequately perform the specialized purpose for which each was developed, this partial collection of solutions highlights the confusing landscape of software management tools. Users who wish to gather information about the software on their computer have to go to multiple applications which launch from different locations or use different commands. The information displayed in each application is not always usable by any but the most advanced users. For example, task manager 203 presents the filename of a file initiating a particular process, but the user would have to look elsewhere to find out what application is associated with the file, how it was initiated, when it was installed, whether it is a security risk, and so forth. Ultimately, if a user wants to know what software is installed, is available for installation, is launched at startup, is currently running, or is a security threat, the user has to view multiple programs, launch them in differing ways from different locations, and interpret differing amounts of complex information.

It would therefore be an enhancement for users to view and control their computer software within a single and consistent interface which presents information in an efficient, usable manner.

### SUMMARY OF THE INVENTION

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the more detailed description below.

Aspects of the invention provide for managing software installed on a computer. A selection of software information views may be displayed in a first region of an interface. When one of the views is selected, a second region of the interface displays the associated software information, which may take the form of a list of software installed on the computer, a list of software updates available to the computer, and a list of software running on the computer. Additionally, a third region of the interface may display additional information about a selected piece of software, and a fourth region of the interface may display commands associated with a selected piece of software.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 is a functional block diagram of an operating environment that may be used for one or more aspects of an illustrative embodiment of the invention;

FIGS. 2A-2F depict a collection of prior art software management tools;

FIG. 3 depicts a layout for a software management interface provided by an illustrative embodiment of the invention;

FIG. 4 depicts a software management tool provided by an illustrative embodiment of the invention;

FIGS. 5A-5D depict additional views for a software management tool provided by one or more illustrative embodiments of the invention; and

FIG. 6 is a flowchart showing a method for managing software on a computer provided by an illustrative embodiment of the invention.

### DETAILED DESCRIPTION OF THE EMBODIMENTS

In the following description of various illustrative embodiments, reference is made to the accompanying drawings, which form a part hereof, and in which are shown by way of illustration various embodiments in which the invention may be practiced. It is to be understood that other embodiments may be utilized and structural and functional modifications may be made, without departing from the scope and spirit of the present invention.

Illustrative Operating Environment

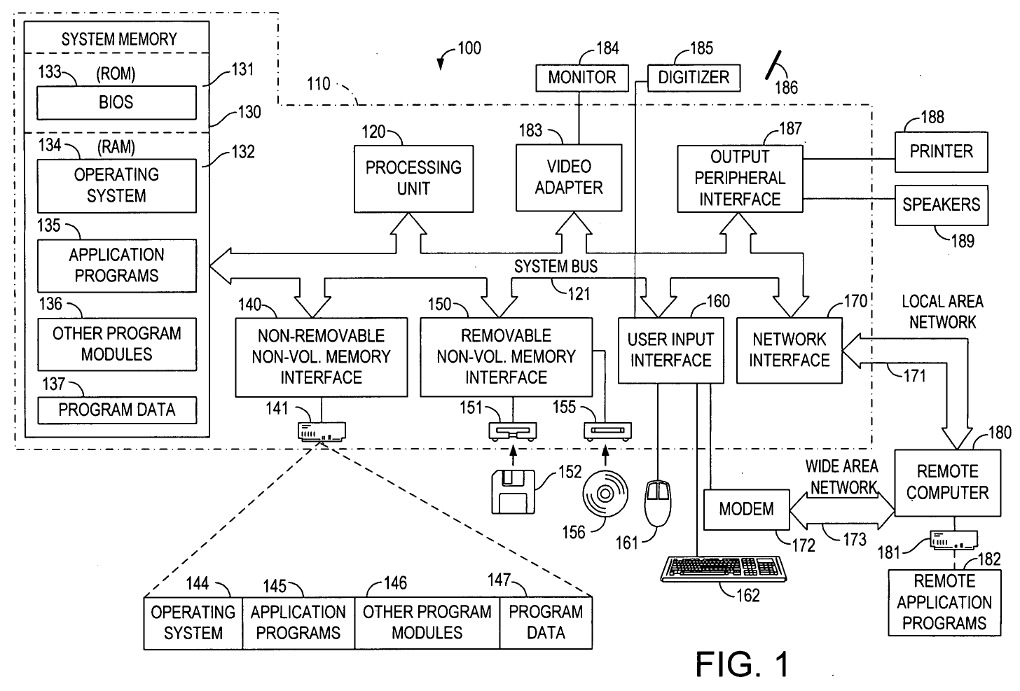

FIG. 1 illustrates an example of a suitable computing system environment 100 in which aspects of the invention may be implemented. Computing system environment 100 is only one example of a suitable computing environment and is not intended to suggest any limitation as to the scope of use or functionality of the invention. Neither should computing system environment 100 be interpreted as having any dependency or requirement relating to any one or combination of components illustrated in illustrative computing system environment 100.

The invention is operational with numerous other general purpose or special purpose computing system environments or configurations. Examples of well known computing systems, environments, and/or configurations that may be suitable for use with the invention include, but are not limited to, personal computers (PCs); server computers; hand-held and other portable devices such as personal digital assistants (PDAs), tablet PCs or laptop PCs; multiprocessor systems; microprocessor-based systems; set top boxes; programmable consumer electronics; network PCs; minicomputers; mainframe computers; distributed computing environments that include any of the above systems or devices; and the like.

Aspects of the invention may be described in the general context of computer-executable instructions, such as program modules, being executed by a computer. Generally, program modules include routines, programs, objects, components, data structures, etc. that perform particular tasks or implement particular abstract data types. The invention may also be operational with distributed computing environments where tasks are performed by remote processing devices that are linked through a communications network. In a distributed computing environment, program modules may be located in both local and remote computer storage media including memory storage devices.

With reference to FIG. 1, illustrative computing system environment 100 includes a general purpose computing device in the form of a computer 110. Components of computer 110 may include, but are not limited to, a processing unit 120, a system memory 130, and a system bus 121 that couples various system components including system memory 130 to processing unit 120. Processing unit 120 may include a single processor or multiple processors working together. Processing unit 120 may be referred to as a central processing unit, or CPU. System bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Advanced Graphics Port (AGP) bus, and Peripheral Component Interconnect (PCI) bus, also known as Mezzanine bus.

Computer 110 typically includes a variety of computer-readable media. Computer readable media can be any available media that can be accessed by computer 110 such as volatile, nonvolatile, removable, and non-removable media. By way of example, and not limitation, computer-readable media may include computer storage media and communication media. Computer storage media may include volatile, nonvolatile, removable, and non-removable media implemented in any method or technology for storage of information such as computer-readable instructions, data structures, program modules or other data. Computer storage media includes, but is not limited to, random-access memory (RAM), read-only memory (ROM), electrically-erasable programmable ROM (EEPROM), flash memory or other memory technology, compact-disc ROM (CD-ROM), digital video disc (DVD) or other optical disk storage, magnetic cassettes, magnetic tape, magnetic disk storage or other magnetic storage devices, or any other medium which can be used to store the desired information and which can accessed by computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF) (e.g., BLUETOOTH, WiFi, UWB), optical (e.g., infrared) and other wireless media. Any single computer-readable medium, as well as any combinations of multiple computer-readable media are intended to be included within the scope of the term computer-readable medium.

System memory 130 includes computer storage media in the form of volatile and/or nonvolatile memory such as ROM 131 and RAM 132. A basic input/output system (BIOS) 133, containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates software in the form of computer-executable instructions including operating system 134, application programs 135, other program modules 136, and program data 137.

Computer 110 may also include other computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD-ROM, DVD, or other optical media. Other computer storage media that can be used in the illustrative operating environment include, but are not limited to, magnetic tape cassettes, flash memory cards, digital video tape, solid state RAM, solid state ROM, and the like. Hard disk drive 141 is typically connected to system bus 121 through a non-removable memory interface such as an interface 140, and magnetic disk drive 151 and optical disk drive 155 are typically connected to system bus 121 by a removable memory interface, such as an interface 150.

The drives and their associated computer storage media discussed above and illustrated in FIG. 1 provide storage of computer-readable instructions, data structures, program modules and other data for computer 110. In FIG. 1, for example, hard disk drive 141 is illustrated as storing an operating system 144, application programs 145, other program modules 146, and program data 147. Note that these components can either be the same as or different from operating system 134, application programs 135, other program modules 136, and program data 137, respectively. Operating system 144, application programs 145, other program modules 146, and program data 147 are assigned different reference numbers in FIG. 1 to illustrate that they may be different copies. A user may enter commands and information into computer 110 through input devices such as a keyboard 162 and pointing device 161, commonly referred to as a mouse, trackball or touch pad. Such pointing devices may provide pressure information, providing not only a location of input, but also the pressure exerted while clicking or touching the device. Other input devices (not shown) may include a microphone, joystick, game pad, satellite dish, scanner, or the like. These and other input devices are often coupled to processing unit 120 through a user input interface 160 that is coupled to system bus 121, but may be connected by other interface and bus structures, such as a parallel port, game port, universal serial bus (USB), or IEEE 1394 serial bus (FIREWIRE). A monitor 184 or other type of display device is also coupled to the system bus 121 via an interface, such as a video adapter 183. Video adapter 183 may have advanced 2D or 3D graphics capabilities, in addition to its own specialized processor and memory.

Computer 110 may also include a digitizer 185 to allow a user to provide input using a stylus 186. Digitizer 185 may either be integrated into monitor 184 or another display device, or be part of a separate device, such as a digitizer pad. Computer 110 may also include other peripheral output devices such as speakers 189 and a printer 188, which may be connected through an output peripheral interface 187.

Computer 110 may operate in a networked environment using logical connections to one or more remote computers, such as a remote computer 180. Remote computer 180 may be a personal computer, a server, a router, a network PC, a peer device or other common network node, and typically includes many or all of the elements described above relative to computer 110, although only a memory storage device 181 has been illustrated in FIG. 1. The logical connections depicted in FIG. 1 include a local area network (LAN) 171 and a wide area network (WAN) 173, but may also or alternatively include other networks, such as the Internet. Such networking environments are commonplace in homes, offices, enterprise-wide computer networks, intranets and the Internet.

When used in a LAN networking environment, computer 110 is coupled to the LAN 171 through a network interface or adapter 170. When used in a WAN networking environment, computer 110 may include a modem 172 or another device for establishing communications over WAN 173, such as the Internet. Modem 172, which may be internal or external, may be connected to system bus 121 via user input interface 160 or another appropriate mechanism. In a networked environment, program modules depicted relative to computer 110, or portions thereof, may be stored remotely such as in remote storage device 181. By way of example, and not limitation, FIG. 1 illustrates remote application programs 182 as residing on memory device 181. It will be appreciated that the network connections shown are illustrative and other means of establishing a communications link between the computers may be used.

Software Explorer

The term software is used to describe computer-executable code, stored on a computer readable medium or in memory, used to pass instructions to a computer. It may include code contained in executable applications, dynamically linked code libraries, script files, and so forth. A single piece of software may include a single file storing all executable code, or a collection of files storing bits and pieces of code. Installed software may include code, programs, applications, and so forth executable by a computer.

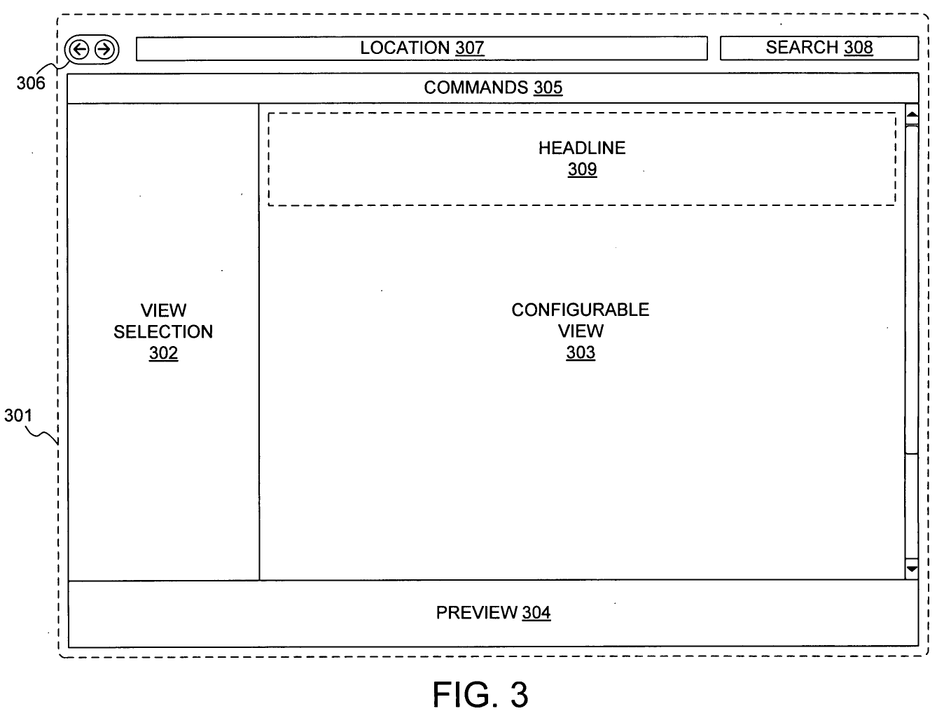

FIG. 3 depicts a display layout 301 for a software management interface provided by an illustrative embodiment of the invention. Those of ordinary skill in the art understand that alternative layouts are possible which are within the scope of the invention. Layout 301 may be implemented as the contents of a window in a graphical operating system such as the Microsoft Windows® brand operating system displayed on monitor 184 or other display device by computer 110. A user may interact with the contents of layout 301 via pointing device 161, keyboard 162, or any other input device. Computer 110, upon receiving input from a user, from a network, from other software operating on computer 110, or from another source, may update the interface to reflect recent changes or otherwise respond to the input.

Layout 301 includes view selection region 302 which displays a list or collection of software information views. The views may be displayed as textual view names, as icons, or some other meaningful representation. They may be displayed as a list, as a tree, or in any other fashion. Configurable view region 303 displays a list, a form, or other representation of information about software installed on computer 110, depending on which software information view is presently selected from region 302. View region 303 may include headline 309 which may provide an explanation of the currently displayed view, instructions on interacting with the view, and possibly other content related to the view such as graphics and icons. The remaining contents of view region 303 may include information related to software, including icons, filenames, user-friendly names, publishers, memory and disk sizes, important dates, and so forth. A user-friendly name may be a name associated with software which provides meaning as to the contents and function of a collection of code. This may be a descriptive file name, a deployment name for a collection of related files, or any other name which is understandable by a layperson unfamiliar with computers.

Configurable view region 303 may be accompanied by preview region 304. Preview region 304 may provide information about a presently displayed information view. This may include comments or instructions related to the view, summary information such as total size of software installed or running, free disk space, and so forth. When a particular item within configurable view region 303 is selected, the contents of preview region 304 may change in order to display more information about the selected item. This may include an application icon, a filename, a user-friendly name, a publisher, a version, a drive or network location, support information, memory size, date of installation, time of launch, and other relevant information.

Configurable view region 303 may also be accompanied by commands region 305, which may include actions related to the currently displayed information view. When a particular information view is selected in the view selection region 302, the commands region 305 is updated to display buttons, links, or other interactive controls. The controls display for a user the available commands which are associated with the current view. The commands may enable a user to control or otherwise interact with the software being displayed in configurable view region 304. When a particular item is selected, a user may be able to click on a command in the commands region 305, controlling or otherwise interacting with the software represented by the selected item.

In addition to the regions described above, layout 301 may also include navigation buttons 306, location bar 307, and search bar 308. Navigation buttons 306 may be used to simplify navigating between the various information views by enabling users to quickly go back or forward between views. Location bar 307 may be used to display a location for the current information view to put the view in context or to provide alternative paths to the information. Location bar 307 may sometimes be referred to as a breadcrumb bar as it may provide users with a step by step route to the presently displayed information view, e.g., by presenting a file path and file name, a menu hierarchy, a metadata hierarchy, or the like. Search bar 308 may provide alternative means for accessing information about a particular piece of software. For example, a user may input the name of a piece of software into search bar 308. The name entered may be used to search a list of installed or installable software, and the user may then be taken to a particular view showing information about that software.

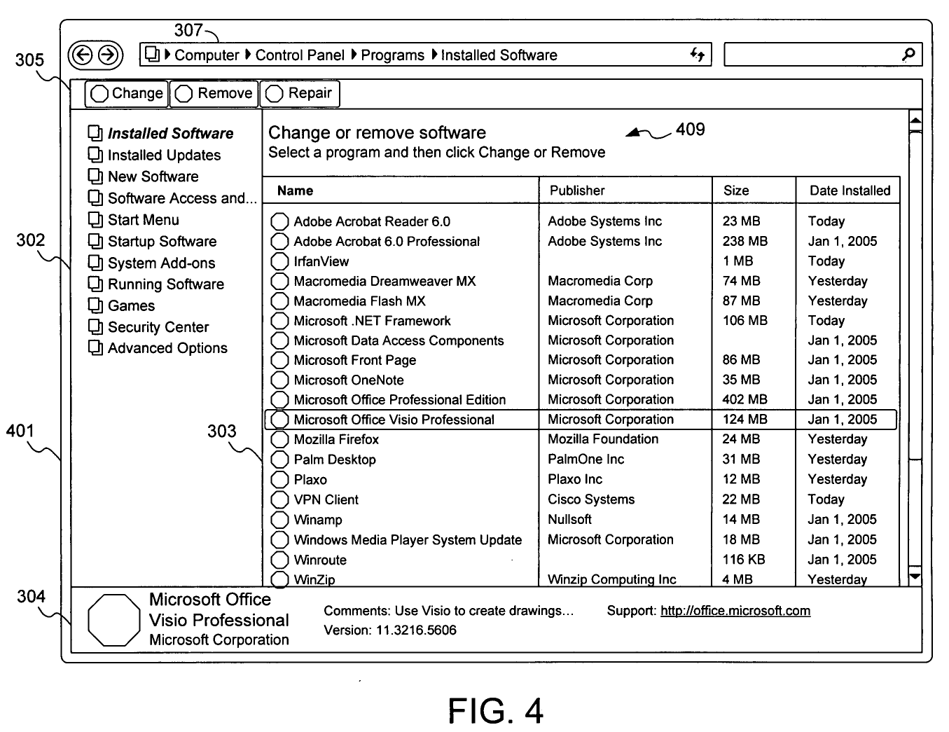

FIG. 4 depicts software management window 401 according to aspects of an illustrative embodiment of the invention. Window 401 provides content for layout 301 introduced above. Here, view selection region 302 is populated with a list of available views presenting information about software installed or installable on computer 110. The list of views displayed in view selection region 302 may change dynamically. Views may be nested for ease of viewing, appearing in a tree-type or similar hierarchy. Differing embodiments may order a list of views differently. A list of possible views is set forth below in tabular form. The list is not exhaustive, and other views may be available:

TABLE 1
Software Information Views

| View | Description |
|---|---|
| Installed Software | View software installed on a computer. User may change, remove, |
| | or repair software. May display user-friendly |
| | name, version, publisher, comments, support link, |
| | filename(s), installation date, last used date, size, owner, |
| | company, location, icon, etc. |
| Installed Updates | View software updates installed on a computer. User may |
| | change, remove or repair updates. May display icon, user- |
| | friendly name, update name, version, publisher, |
| | comments, support link, installation date. |
| Add New Software | View software available for installation from a network or |
| | storage medium. User may install software. May display |
| | similar information about installable software. |
| Software Access and | View default software selections and access properties. |
| Defaults | User may modify default software and access properties. |
| | May display similar information about software available |
| | for default selection and access properties. |
| Start Menu | View software referenced on a start menu or launch menu. |
| | User may modify software referenced. May display |
| | similar information about software referenced. |
| Startup Programs | View software which runs automatically when an |
| | operating system starts up. User may allow or prevent |
| | software to run at startup. May display similar |
| | information about software, including user-friendly names |
| Running Programs | View software currently running on computer. User may |
| | stop or start running software. May display similar |
| | information about running software, including user- |
| | friendly name, memory usage, CPU usage, current run |
| | status, trust level, etc. |
| Games | View software designated as games installed on computer. |
| | User may play game software. May display similar |
| | information about game software, as well as information |
| | unique to game software. |
| Browser Add-ons | View software installed as add-ons and helpers for a web |
| | browser. User may add, remove, enable or disable add- |
| | ons and helpers. May display information including user- |
| | friendly name, trust rating, installation date, etc. |
| Operating System | View software installed or installable as part of an |
| Components | operating system. User may add or remove operating |
| | system components. May display information about |
| | software components. |
| Suspicious Software | View software deemed suspicious or unreliable installed |
| | on computer. User may remove or modify suspicious |
| | software. May display similar information, including |
| | user-friendly name, publisher, trust rating, reliability |
| | rating, current run status, startup status, installation date, |
| | etc. |
| Services | Viewed software installed as an operating system service. |
| | User may stop, start, enable or disable services. May |
| | display user-friendly name, startup status, current run |
| | status, etc. |
| System Restore | View software installed at certain restore points in the past |
| | on computer. User may roll-back to a restore point, or |
| | create a new restore point. May display similar |
| | information including user-friendly name, installation |
| | date, restore point, etc. |
| File Associations | View software associations with data files. User may |
| | modify file associations. May display similar information |
| | including user-friendly name, file type(s), etc. |
| Operating System | View software updates installed or installable as part of an |
| Updates | operating system. User may install or uninstall operating |
| | system updates. May display similar information about |
| | installable operating system updates. |
| Security Center | View software suspected of being a security risk to |
| | computer 110 or to the user. User may be able to |
| | uninstall, research, or quarantine suspicious software. |

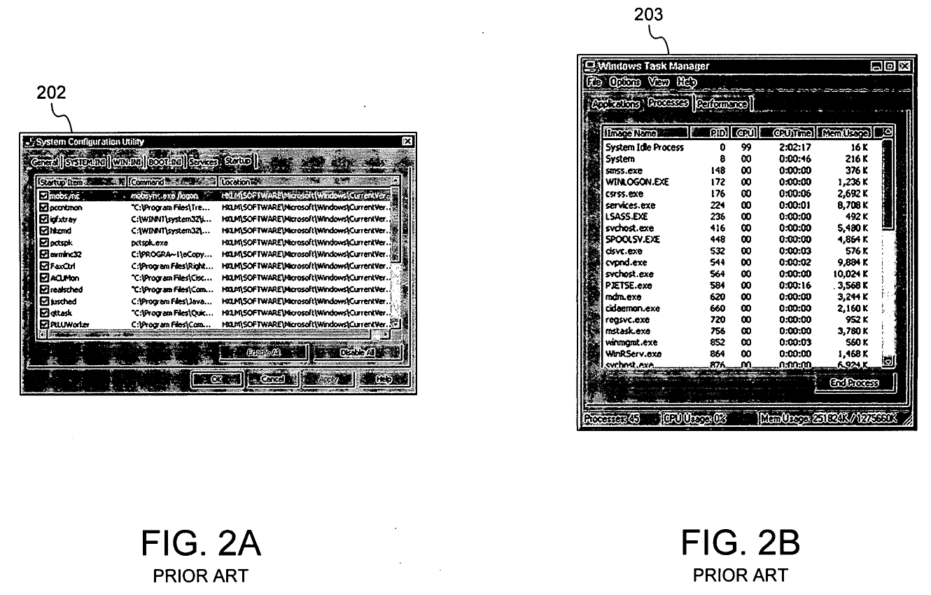

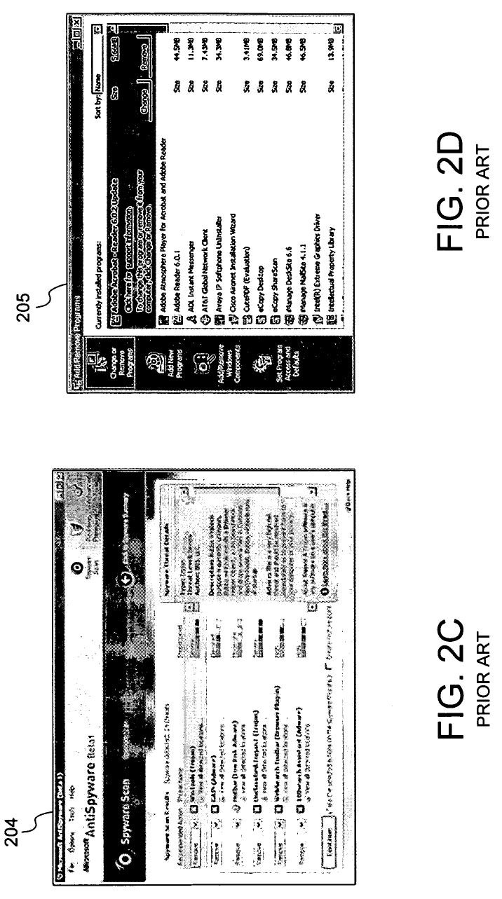

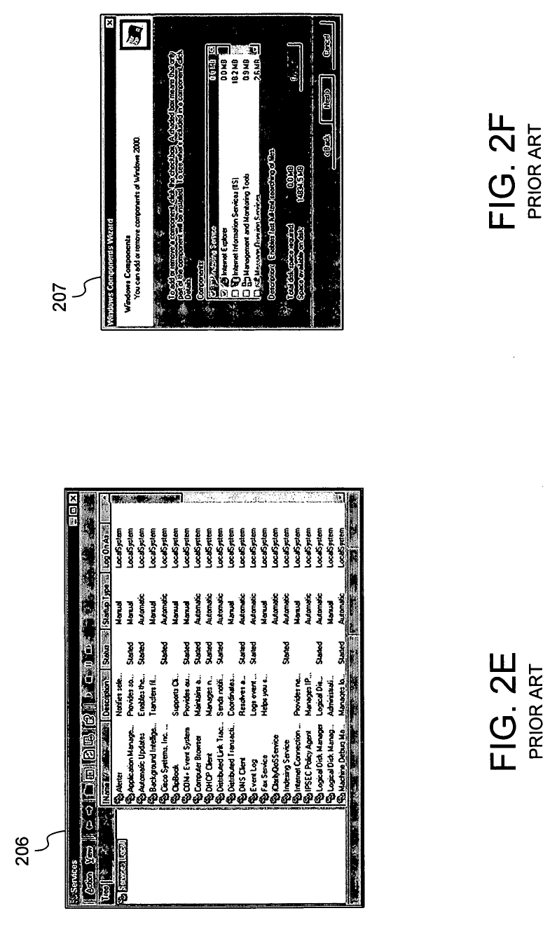

Information used to populate the software views listed in Table 1 may be derived from any number of well-known sources. Sources may include a system information store such as a registry or a database, an operating system kernel, a file system, a heuristic analysis of running software, currently running processes, currently running services, loaded drivers, a launch menu hierarchy, and so forth. Additionally, software information may be derived using previously developed tools, such as those pictured in FIGS. 2A-2F.

Returning to FIG. 4, the selection of “Installed Software” in view selection region 302 modifies configurable view region 303 so as to show a list of software installed on computer 110, introduced by headline text 409. The list may be presented in tabular format, and includes columns displaying for each piece of software a user-friendly name, a publisher, a size, and an installation date. A user may select a particular column heading to sort data in the table using the contents of the column as a sort key. The columns displayed are not exclusive. The user may be able to configure the list to display additional columns, such as those listed above, or that provide additional relevant information.

When an item from configurable view region 303 is selected, preview region 304 may display relevant information about the selected item. This may include an associated icon or graphic, a user-friendly name, comments, version number, a support link, and other information relevant to software installation. Different views may provide different information in preview region 304 when an item is selected, depending on what may be helpful in managing each particular piece of software.

Commands region 305 may also change depending on the current view being displayed. Different sets of actions may be available for the software shown in configurable view region 303, depending on what is relevant to the current view. Here, commands region 305 has buttons for changing, removing, or repairing a selected software installation. When a user selects or clicks on a command button, the appropriate action may execute for whichever piece of software is selected. If necessary, certain commands may be unavailable for certain pieces of software. For example, a user may not be able to simply uninstall the operating system.

Location bar 307 may also change depending on the current view being displayed. The contents of location bar 307 may be updated to reflect a real or virtual location for the current view. Such information may assist a user in understanding the context of the view, and also assist in navigating through multiple views. Items displayed within the location bar may also be selectable, allowing a user to move to another view or location with ease.

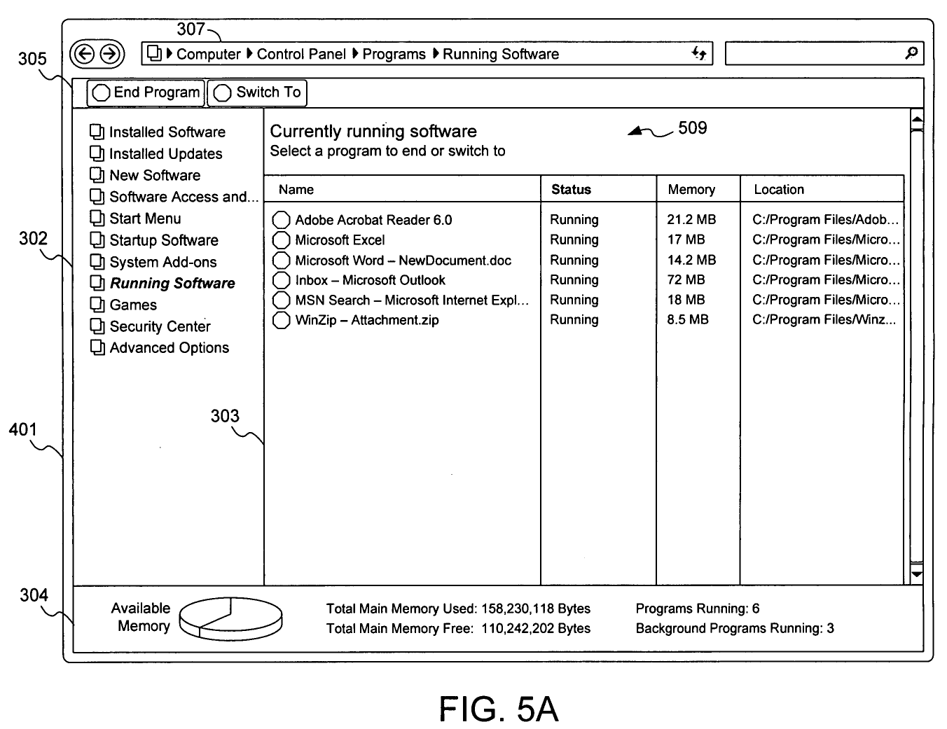

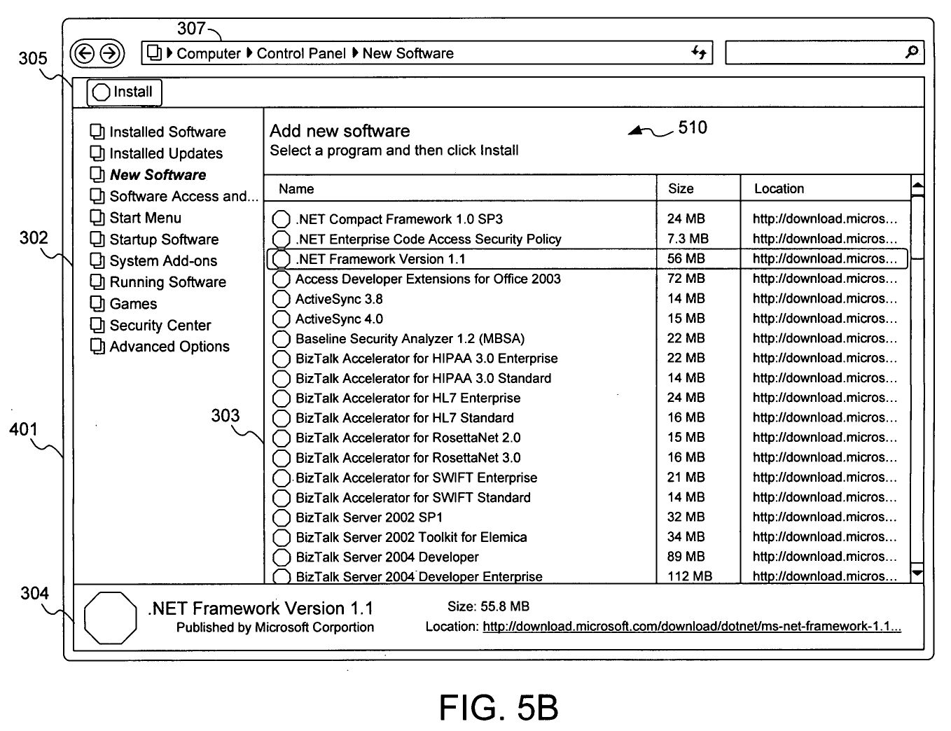

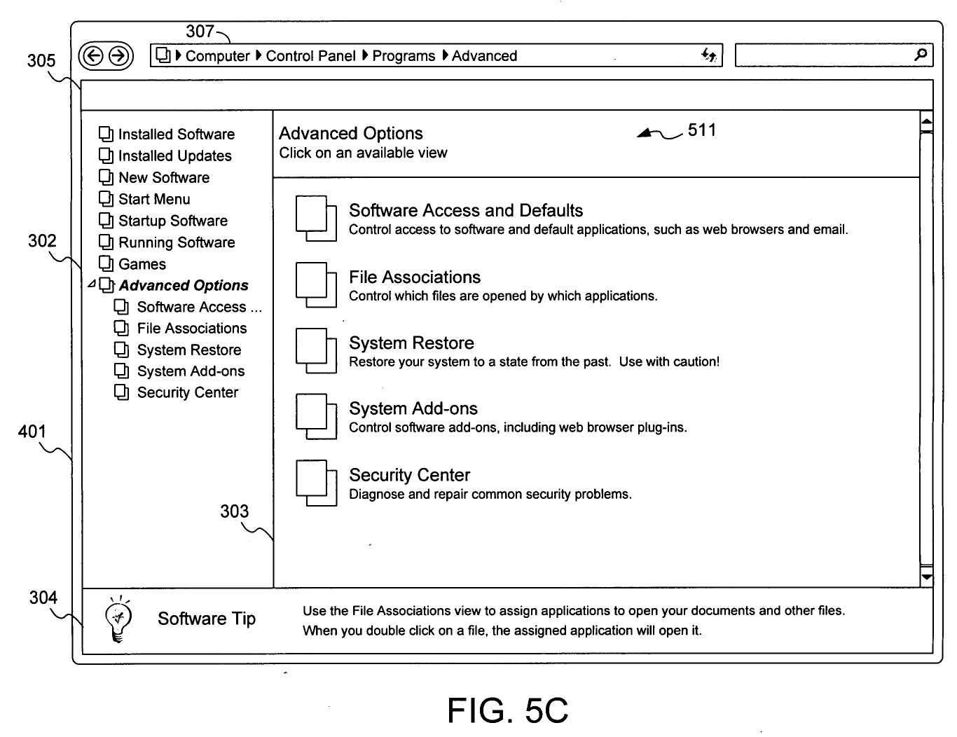

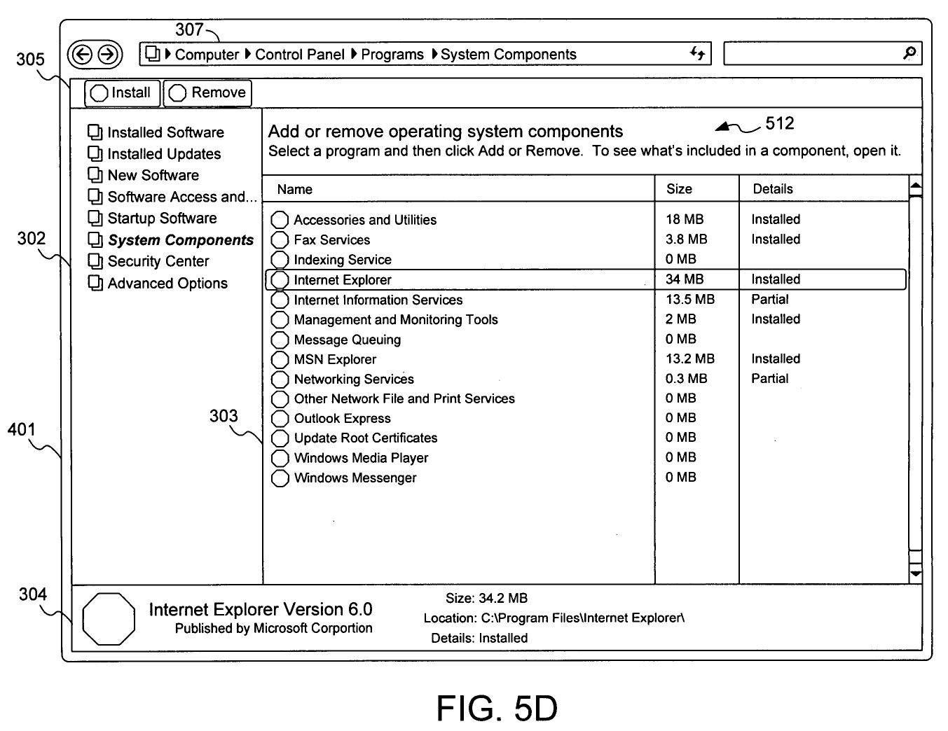

FIGS. 5A-5D display additional views which may be displayed in software management window 401. FIG. 5A depicts software management window 401 according to aspects of an illustrative embodiment of the invention. Here, a different view, “Running Software” is selected within view selection region 302. The contents of configurable view region 303 have been updated to reflect the list of presently running software. Headline 509 describes the current view. No item has been selected in the list of presently running software, and so preview region 304, instead of showing item-specific information, displays general information related to the view. Such general information may include free memory, total memory usage, total storage usage, quantity of software installed or running, and so forth. It also may include graphs, charts, or other graphical representations of software information. Separate commands may be displayed in commands region 305, here allowing a user to terminate a piece of running software, or switch to a piece of running software. In addition, location bar 307 may be updated to reflect a different context or location of the presently displayed view.

FIG. 5B depicts an additional view in software management window 401 according to aspects of an illustrative embodiment of the invention. The view selected in view selection region 302 is “New Software.” The contents of configurable view region 303 now display a listing of software available for installation, along with descriptive headline 510. Location bar 307 is updated to show the context of the new software view, and commands region 305 displays an install buttons which initiates an installation the selected new piece of new software. As with the installed programs view of FIG. 4, an item from the list of new software is selected, and preview region 304 displays more information about the selected software.

FIG. 5C depicts another view in software management window 401 according to aspects of an illustrative embodiment of the invention. The view displayed in configurable view region 303 is a little different. Here, “Advanced Options” is selected in view selection region 302. The selection is merely a folder-type menu item to store additional views without adding additional clutter. Upon selection, the menu item is “opened” to display additional views in an offset manner. And configurable view region 303 displays the same selection of views with more information. In order to choose one of the contained views, a user may either select a view from view selection region 302, or may select the view from within configurable view region 303. Commands region 305 may be left blank since there are currently no actions which may be taken with regard to the displayed view. Additionally, preview region 304 is displayed here showing a software tip. In the absence of more relevant content, preview region 304 may display such tips and suggestions or may remain blank.

FIG. 5D depicts another view in software management window 401 according to aspects of an illustrative embodiment of the invention. Here, “System Components” is selected in view selection region 302. Configurable view region 303 displays a listing of operating system components which may be fully or partially installed, along with information on the size of the installation, and its current installation status. Preview region 304 displays information about a currently selected system component. And location bar 307 is updated to display the context of the current view. Commands region 305 displays install and remove buttons with which a user may modify the installation status of the system components displayed in configurable view region 303.

Some views may not be displayable within configurable view region 303. In such a situation, a separate window or application may be launched with a distinctly separate interface. This may especially true in cases where legacy software components are difficult to update. For example, clicking on “Security Center” in view selection region 302 may cause a new window to open which displays security settings.

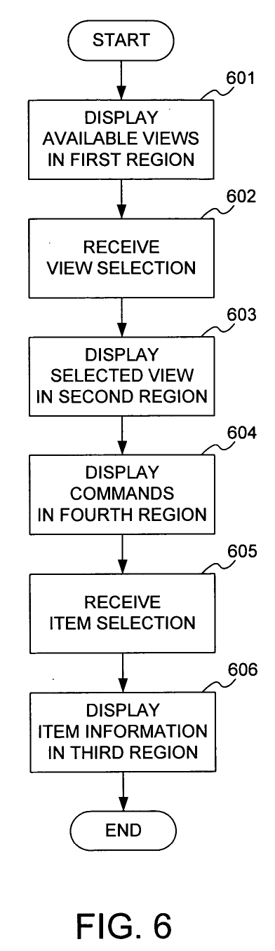

FIG. 6 is a flowchart illustrating a method for managing software on computer 110 provided by aspects of the invention. Within a single interface, at step 601, a list of available software information views is displayed in a first region of the interface. By default, a particular view may be selected, and the other portions of the interface may be updated to reflect that initial selection. At step 602, a user may select a particular software information view and the selection will be received, precipitating the updating of other portions of the interface.

At step 603, a second region of the interface is updated, displaying the selected view. The view may include a list or collection of items including software installed or installable on computer 110. At step 604, a fourth region of the interface is updated to display commands associated with the presently selected view. An item from the second region may be selected by a user, and the selection is received at step 605. Upon selection, the contents of a third region of the interface are updated, displaying information about the selected item.

While the invention has been described with respect to specific examples including presently preferred modes of carrying out the invention, those skilled in the art will appreciate that there are numerous variations and permutations of the above described systems and methods that fall within the spirit and scope of the invention as set forth in the appended claims. A claim element should not be interpreted as being in means-plus-function format unless the phrase “means for”, “step for”, or “steps for” is included in that element. Also, numerically-labeled steps in method claims are for labeling purposes only and should not be interpreted as requiring a particular ordering of steps.

We claim:

1. A method for managing software on a computer, the method comprising steps of:
displaying a first region, comprising a set of available information views related to software stored on the computer, wherein the set of available information views comprises:
software installed on the computer,
software available for installation on the computer, and
software presently running on the computer; and
displaying a second region, comprising a configurable area for displaying information related to software stored on the computer, wherein the information displayed in the second region is dependent on a selected information view from the first region.

2. The method of claim 1, further comprising:
displaying a third region, comprising a configurable area for displaying information related to software stored on the computer, wherein the information displayed in the third region is dependent on a selected item in the second region.

3. The method of claim 1, further comprising:
displaying a third region, comprising a configurable area for displaying available commands, wherein the commands displayed in the fourth region are dependent on a selected information view from the first region.

4. The method of claim 3, further comprising:
receiving a selection of one of the commands displayed in the third region; and
responsive to the selection, performing the selected command with respect to the selected item.

5. The method of claim 1, wherein the set of available information views further comprises:
software installable as one or more components of an operating system.

6. The method of claim 5, wherein the set of available information views further comprises:
software loaded automatically when the operating system loads.

7. The method of claim 6, wherein the set of available information views further comprises:
software installed associated with a web browser.

8. The method of claim 7, wherein the set of available information views further comprises:
software suspected of being a security risk.

9. The method of claim 1, wherein a set of software displayed in the second region corresponding to the selected view in the first region comprises a user-friendly name of an application associated with a displayed list item.

10. The method of claim 1, further comprising:
displaying a third region comprising a context of the selected information view.

11. A computer-readable medium storing computer-executable instructions for performing the steps recited in claim 1.

12. A system for managing software on a computer, the system comprising:
one or more storage media, upon which is installed one or more pieces of software;
a display;
a pointing device; and
a processor configured to:
determine software installed on the storage media;
display in a first region on the display a set of software information views related to the installed software, wherein the set of software information views comprises software installed on the computer, software available for installation, and software running on the computer;
receive via the pointing device a selection of a software information view; and
display in a second region on the display the selected software information view, wherein the selected software information view comprises a set of software.

13. The system of claim 12, wherein the processor is further configured to:
receive via the pointing device a selection of one of the set of software displayed in the second region; and
display in a third region information associated with the selected software.

14. The system of claim 12, wherein the processor is further configured to:
display in a third region commands associated with software in the selected software information view.

15. The system of claim 12, wherein the processor is further configured to:
receive a selection of one of the commands displayed in the third region; and
responsive to the selection, perform the selected command with respect to the selected item.

16. The system of claim 12, wherein the processor is further configured to:
display in a third region a navigation context of the selected information view.

17. The system of claim 12, wherein the software displayed in the second region comprises a user-friendly name of an application associated with a displayed piece of software.

18. The system of claim 12, wherein the set of information views further comprises:
software installable as one or more components of an operating system.

19. The method of claim 18, wherein the set of information views further comprises:
software loaded automatically when the operating system loads.

20. The method of claim 19, wherein the set of information views further comprises:
software installed associated with a web browser.
